(19) United States
(12) Patent Application Publication
(10) Pub. No.: US 2014/0234021 A1
(43) Pub. Date: Aug. 21, 2014

(54) Shaft with a Flange Connection

(71) Applicant: KHD Humboldt Wedag BmbH, Koein (DE)

(72) Inventor: Meinhard Frangenberg, Kuerten (DE)

(21) Appl. No.: 14/347,808

(22) PCT Filed: Sep. 20, 2012
(86) PCT No.: PCT/EP2012/068500

§ 371 Date: Mar. 27, 2014

(30) Foreign Application Priority Data
Sep. 28, 2011 (DE) 202011106443.7

(51) Int. Cl. F16D 1/02

(52) U.S. Cl. CPC F16D 1/02
USPC 403/335

(57) ABSTRACT

A flange connection on a shaft having at least two diameters of different size, wherein the diameter of the flange connection is smaller than a diameter of the roller bearing seat. Machine parts on the shaft can thereby be rapidly and simply interchanged without the flange having to be removed in the process.

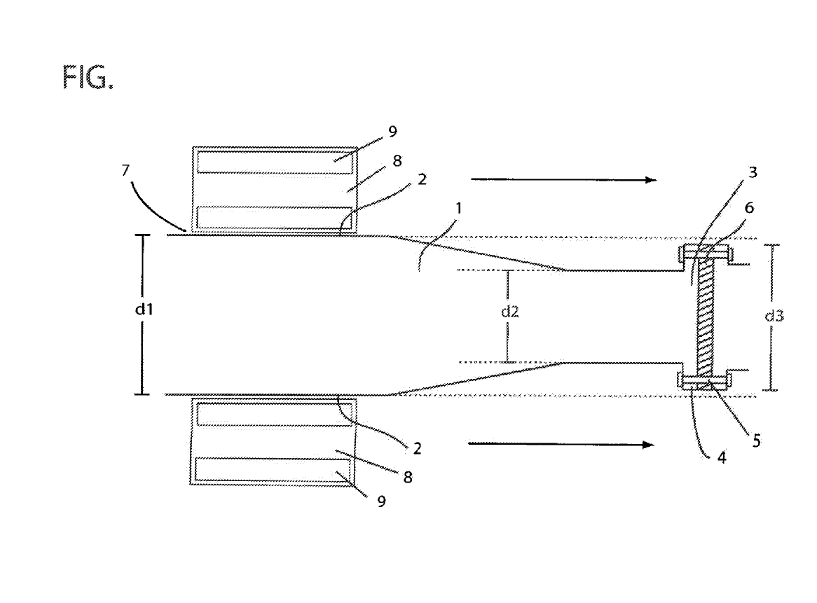

### CROSS-REFERENCES TO RELATED APPLICATIONS

This application claims the benefit of the German patent application No. 202011106443.7 filed on Sep. 28, 2011, the entire disclosures of which are incorporated herein by way of reference.

### BACKGROUND OF THE INVENTION

The invention relates to a flange connection on a shaft, which flange connection makes it possible to replace machine parts on the shaft rapidly and simply, without the flange having to be removed in the process.

Flange is generally used to denote an attachment to components such as pipes, shafts or housings, which attachment serves to connect or to couple the respective component to another element. A characteristic of the flange is the flange plates which surround the elements in a circularly annular manner at their connecting point and by way of which the flange is connected by pressing onto one another. The connection can be of irreversible design, for example by welding of the flange plates, or else of reversible design, for example by screwing of the flange plates to holes which are provided for this purpose.

In engineering, flanges are frequently used for the leadthrough of shafts, for example in the case of planetary gear mechanisms between the gear mechanism and the shaft. In its simplest form, a shaft is a rod-shaped machine element which is used to transmit rotational movements and torques and to mount rotating parts.

Here, in addition to the pure positioning of the shaft with respect to the gear mechanism, the flange also assumes the task of absorbing the torsional forces which are transmitted during the rotation of the shaft.

Planetary gear mechanisms are used, inter alia, in roll presses. Roll presses usually consist of two equally large, rotatably mounted rolls which rotate in each case in the opposite direction at an identical circulating speed and between which the material to be milled is pressed through and comminuted. The drive of the very heavy rolls which can be 50 t or more per item requires the transmission of a very high torque which is transmitted to the flange. The flange connection is therefore exposed to a continuous, considerable loading during operation of the rolls. In order that the flange is not broken or deformed under this loading, the flange is of more or less wide design, that is to say it comprises relatively large flange plates which ensure a sufficiently large frictional area between the flange plates, as a result of which the force is distributed to a correspondingly large frictional area. As a result, the flange gains stability. However, a large flange also has the consequence that the diameter of the flange is considerably greater than the diameter of the shaft. This in turn has the disadvantage that the machine elements which are arranged on the shaft can then no longer be readily removed at the hub along the shaft, since they then no longer fit through the wider flange, which presents a great obstacle, for example, when replacing rolls or the antifriction bearings in roll presses.

This problem is usually solved by a section of the shaft between the shaft and flange being connected releasably to one another, with the result that the flange can be separated from the shaft. This can take place, for example, by use of a mechanical or hydraulic shrink disk. A shrink disc is a likewise flange-shaped, non-positive shaft/hub connection which is applied to the shaft from the outside and which generates pressure on the shaft as a result of the reduction of its internal diameter via conical pressing faces of the outer parts, as a result of which a frictional connection is produced between the shaft and the hub by way of a press fit. The disadvantage of a shrink disk is, however, that the shrink disk has to be dismantled every time in order to replace the rolls and has to be mounted again after the replacement, which increases the time spent on the replacement considerably, particularly in the case of mechanical shrink disks.

A solution would therefore be desirable, by way of which the elements which are fastened to a shaft can be removed and replaced in a rapid and uncomplicated manner without further intermediate steps.

### SUMMARY OF THE INVENTION

The object is achieved by a shaft of a high pressure roll press, which shaft has at least one flange which is situated on the shaft, the shaft having at least two diameters of different size, and the diameter of the flange being smaller than the diameter of the antifriction bearing seat.

By virtue of the fact that the shaft has diameters of different size, according to the invention the flange can then be attached at a relatively narrow location of the shaft. It is possible in this way, despite the flange plates, to keep the diameter of the flange connection smaller than the wider diameter of the shaft, on which the antifriction bearing is situated. This has the advantage that the antifriction bearing which is attached to the hub, or further machine elements, can be removed simply by being guided along the shaft, without the flange impeding the removal. In this way, the antifriction bearing can be replaced relatively simply and rapidly.

Since the flange does not have to be removed in order to remove the antifriction bearing, the use of an expensive hydraulic or mechanical shrinking means can therefore be omitted.

It is a further advantage of the construction according to the invention that merely one force direction is required to move the elements in order to replace the elements. This is of great advantage particularly in the case of the very large and heavy rolls of the roll presses, since their movement requires a large exertion of force and a special lifting device is usually required. By way of the construction according to the invention, in contrast, the element is moved only in the axial direction of the shaft, which considerably facilitates the replacement.

The shaft usually has a circular cross section; in principle, however, cross sections which differ herefrom are also conceivable. For example, the cross section can be oval or star-shaped. The diameter is then defined as the greatest possible distance of two points which are situated on the cross section.

Since, according to the invention, the diameter of the flange is not greater than the widest region of the shaft, the flange plates also must not be too wide. However, a comparatively small flange results correspondingly in a relatively small contact area of the flange plates. As a consequence, the torque during the rotation of the shaft is transmitted to a relatively small area of the flange. It is therefore provided in one advantageous embodiment of the invention to insert one or more friction disks having a high coefficient of friction between abutting flanges. The friction disks ensure an increase in the static friction between the flanges and therefore bring about greater stability of the flange connection. As a result, the diameter of the flanges can be kept small.

In a further advantageous refinement of the invention, the flange is forged on the shaft. Since the removal is no longer required, the more complicated screw connection is superfluous. In addition, a welded flange also has a relatively high mechanical stability.

The flange can also have more than two diameters. For example, the diameter of the shaft can decrease in steps in the direction of the flange. It is also conceivable that the shaft tapers conically in the axial direction.

### BRIEF DESCRIPTION OF THE DRAWINGS

The invention will be explained in greater detail using the following FIGURE.

The FIGURE is a side view of a shaft with a flange connection embodying the principles of the present invention.

### DETAILED DESCRIPTION OF THE PREFERRED EMBODIMENTS

The FIGURE shows a shaft 1 which has a diameter d1 at the location of the antifriction bearing seat 2. The shaft 1 tapers conically in the direction of the flange 3 and has a diameter d2 in the narrower region. The flange 3 is situated with the flange plates 4 at the narrower end of the shaft 1 with a diameter d3, which flange 3 is forged on the shaft 1 in this example and is therefore in one piece with the shaft. The flange plate 4 of one shaft 1 is connected to the flange plate 4 of an abutting shaft 1 by screws 5. In order to transmit the torque, a friction disk 6 is attached between the flanges 3, which friction disk 6 ensures that the forces which are caused by the rotation are distributed homogeneously on the flange plates 4. On the wider end of the shaft 1, an antifriction bearing 8 with the rolling bodies 9 which are situated therein is attached at the hub 7. The diameter d3 of the flange connection 3 is somewhat smaller than the inner diameter d1, on which the antifriction bearing 8 is situated. It is therefore possible, after release of the flange connection 3 by removal of the screws 5, to remove the antifriction bearing 8 at the hub 7 along the arrow direction on the shaft, without the flange being an obstacle in the process.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF DESIGNATIONS

1 Shaft
2 Antifriction bearing seat
3 Flange
4 Flange plates
5 Screw
6 Friction disk
7 Hub
8 Antifriction bearing
9 Rolling body
d1, d2 Diameter of the shaft
d3 Diameter of the flange connection

1-5. (canceled)

6. A shaft of a high pressure roll press comprising:
an antifriction bearing seat portion with a first diameter,
a second, smaller shaft diameter spaced away from the antifriction bearing seat, and
at least one flange extending radially outwardly from the second, smaller diameter,
wherein an outer diameter of the flange is smaller than the diameter of the antifriction bearing seat portion.

7. The shaft as claimed in claim 6, wherein the at least one flange is forged on the shaft.

8. The shaft as claimed in claim 6, wherein the shaft tapers partially conically in an axial direction.

9. A shaft assembly of a high pressure roll press having a first shaft arranged in an end abutting relationship with a second shaft, comprising:
the first shaft of the shaft assembly comprising:
an antifriction bearing seat portion with a first diameter,
a second, smaller shaft diameter spaced away from the antifriction bearing seat, and
at least one flange extending radially outwardly from the second, smaller diameter,
wherein an outer diameter of the flange is smaller than the diameter of the antifriction bearing seat portion,
the second shaft of the shaft assembly being arranged coaxial with the first shaft and having at least one flange aligned with the at least one flange of the first shaft,
one or more friction disks arranged between the at least one flange of the first shaft and the at least one flange of the second shaft in order to increase the static friction between the two aligned flanges.

10. The shaft assembly as claimed in claim 9, wherein the two aligned flanges are connected to each other by one of screws and by welding.
